(19) United States
(12) Patent Application Publication
(10) Pub. No.: US 2014/0192058 A1
(43) Pub. Date: Jul. 10, 2014

(54) IMAGE PROCESSING APPARATUS, IMAGE PROCESSING METHOD, AND RECORDING MEDIUM STORING AN IMAGE PROCESSING PROGRAM

(71) Applicants: Yu KODAMA, Kanagawa (JP); Katsuyuki Omura, Tokyo (JP); Junichi Takami, Kanagawa (JP)

(72) Inventors: Yu KODAMA, Kanagawa (JP); Katsuyuki Omura, Tokyo (JP); Junichi Takami, Kanagawa (JP)

(21) Appl. No.: 14/133,931

(22) Filed: Dec. 19, 2013

(30) Foreign Application Priority Data
Jan. 7, 2013 (JP) 2013-000490

(51) Int. Cl. G06T 11/20

(52) U.S. Cl. CPC G06T 11/203
USPC 345/442; 345/443

(57) ABSTRACT

An image processing apparatus measures duration of the drawing operation by using coordinate information that indicates coordinate instructed to draw and time information that indicates time when the coordinates are detected, determines predicted time in accordance with the duration of the drawing operation, and generates an drawn image by calculating the predicted coordinates after the predicted time passes. The image processing apparatus calculates a characteristic value of the drawing operation by using the coordinate information and the time information and measures the duration of the drawing operation in case the characteristic value of the drawing operation is less than predetermined threshold value.

### CROSS-REFERENCE TO RELATED APPLICATION

This patent application is based on and claims priority pursuant to 35 U.S.C. §119 to Japanese Patent Application No. 2013-000490, filed on Jan. 7, 2013 in the Japan Patent Office, the entire disclosure of which is hereby incorporated by reference herein.

### BACKGROUND

1. Technical Field

The present invention relates to an image processing apparatus, image processing method, and recording medium storing an image processing program.

2. Background Art

Electronic whiteboards on which users can draw characters, numbers, and graphics on their large-screen displays are widely used in conferences at corporations, educational institutes, and governmental agencies, etc. Regarding these electronic whiteboards, a technology that predicts drawing by a user and draws it on a screen in order to eliminate display delay has been proposed (e.g., JP-2006-178625-A).

### SUMMARY

An example embodiment of the present invention provides an image processing apparatus that includes a predicted time calculator that calculates predicted time, a predicted coordinate calculator that calculates predicted coordinates after the predicted time passes, and an image generator that generates a drawn image after the predicted time passes by using the predicted coordinates. The predicted time calculator measures duration of a drawing operation by using coordinate information that indicates coordinate instructed to draw and time information that indicates time when the coordinates are detected and determines the predicted time in accordance with the duration of the drawing operation

An example embodiment of the present invention include an image processing method executed by the image processing apparatus, and a non-transitory recording medium storing a program that causes the computer to implement the image processing method.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a block diagram illustrating a hardware configuration and functional configuration of an image processing apparatus as an embodiment of the present invention.

FIG. 2 is a diagram illustrating a coordinate information and time information buffering method employed by the image processing apparatus as an embodiment of the present invention.

FIG. 3 is a functional block diagram of a predicted time calculator in the image processing apparatus as an embodiment of the present invention.

FIG. 4 is a flowchart illustrating a process executed by a controller in the image processing apparatus as an embodiment of the present invention.

FIG. 5 is a conceptual diagram illustrating a method of generating a drawn image with the image processing apparatus as an embodiment of the present invention.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

In the following embodiment, an image processing apparatus, image processing method, and recording medium storing an image processing program that calculates predicted coordinates in accordance with drawing patterns are provided.

The image processing apparatus measures the duration of a drawing operation by using coordinate information that indicates coordinates where drawing is instructed and time information that indicates time when the coordinate are detected, decides predicted time in response to the duration of the drawing operation, and generates a drawn image by calculating predicted coordinates after the predicted time passes.

If the predicted time is calculated by calculating delay time using hardware performance, the coordinate input apparatus cannot calculate predicted coordinates in response to patterns drawn by the user. Consequently, with operations in which prediction error is already prominent, such as drawing small characters and wavy lines, prediction accuracy deteriorates. By adopting the configuration described above, in one example, the image processing apparatus can calculate predicted coordinates in accordance with drawing patterns and improve prediction accuracy for drawing.

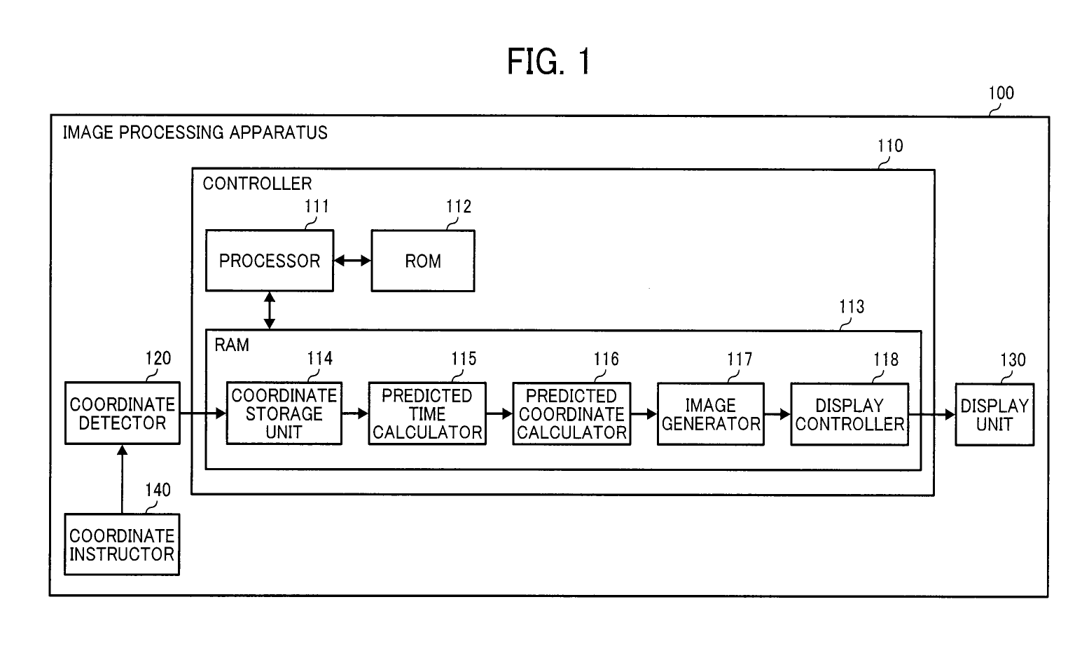

FIG. 1 is a block diagram illustrating a hardware configuration and functional configuration of an image processing apparatus. An image processing apparatus 100 generates an image that a user instructs to draw and display the image. The hardware configuration and functional configuration of the image processing apparatus 100 is described below with reference to FIG. 1.

The image processing apparatus 100 includes a controller 110, a coordinate detector 120, and a display unit 130.

The controller 110 executes an image processing method provided in this embodiment and includes a processor 111, a ROM 112, and a RAM 113.

The processor 111 is a processing unit such as a CPU and MPU, executes Operating Systems (OS) such as Windows, UNIX, Linux, TRON, ITRON, and μITRON, and runs a program in this embodiment written in program languages such as assembler, C, C++, Java, Javascript, Perl, Ruby, and Python. The ROM 112 is a nonvolatile memory that stores a boot program etc. such as BIOS and EFI.

The RAM 113 is a main storage unit such as DRAM and SRAM and provides an execution area to execute the program in this embodiment. The processor 111 reads the program in this embodiment from a secondary storage unit (not shown in figures) that stores programs and various data etc. continually, expands the program into RAM 113, and executes the program.

The program in this embodiment includes a coordinate storage unit 114, a predicted time calculator 115, a predicted coordinates calculator 116, an image generator 117, and a display controller 118 as program modules. These program modules generates an drawn image by using coordinate where a user instructs to draw and time when the coordinates are detected and display the drawn image on the display unit 130 as a display device. In this embodiment, these functional units are implemented by expanding them into the RAM 113. However, these functional units can be implemented in a semiconductor device such as ASIC in other embodiments.

The coordinate detector 120 detects contact or approach of an object such as a coordinate instructor 140 that instructs coordinate to be drawn, calculates coordinate where a user instructs to draw, and outputs the coordinate. In this embodiment, a coordinate inputting/detecting device that uses an infrared shadowing method described in JP-2008-176802-A is adopted as the coordinate detector 120. In the coordinate inputting/detecting device, two optical emitting/receiving units mounted on both lower ends of the display unit 130 emit plural infrared rays in parallel with the display unit 130 and receives light reflected on same light path by reflecting components mounted around the display unit 130. The coordinate detector 120 calculates coordinate position of an object by using location information of infrared shadowed by the object.

In other embodiments, a touch panel that uses an electrostatic capacity method and specifies coordinate position of an object by detecting change of electrostatic capacity, a touch panel that uses a resistive film method that specifies coordinate position of an object from change of voltage in opposed two resistive films, and a touch panel that uses an electromagnetic induction method that specifies coordinate position of an object by detecting electromagnetic induction generated when the object contacts the display unit 130 can be adopted.

After detecting contact or approach of the object, the coordinate detector 120 generates information that indicates coordinate where the user instructs to draw by the object (hereinafter referred to as “coordinate information”) and time information that indicates time when the coordinates are detected, and output them to the coordinate storage unit 114.

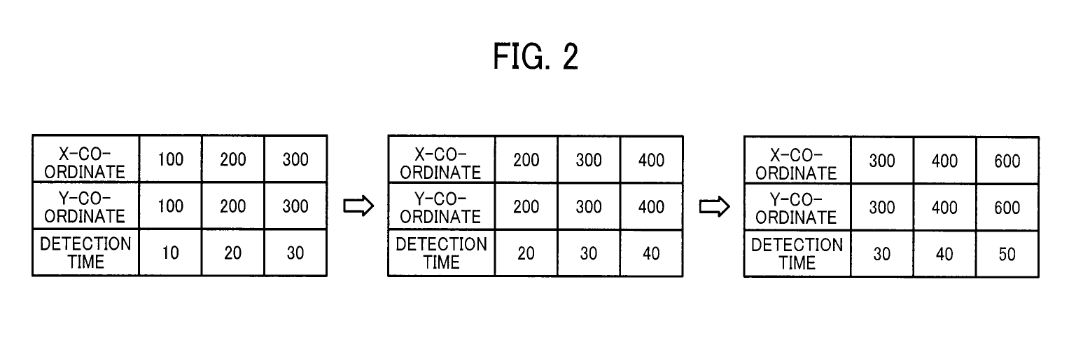

The coordinate storage unit 114 buffers the coordinate information and the time information from the coordinate detector 120. FIG. 2 is a diagram illustrating a method of buffering the coordinate information and the time information. After receiving the coordinate information and the time information from the coordinate detector 120, the coordinate storage unit 114 discards the oldest coordinate information and time information buffered already and stores the coordinate information and the time information received newly.

In FIG. 2, coordinate information whose detection time is “t=10, 20, 30” are stored in a buffer memory whose detection time is “t=30”. In this case, if the coordinate storage unit 114 receives new coordinate information (X-coordinate: 400 and Y-coordinate: 400) from the coordinate detector 120, the coordinate information and time information whose detection time is “t=10” is discarded, and the new coordinate information (X-coordinate: 400 and Y-coordinate: 400) and time information that indicates detection time when the coordinate was detected (t=40) is stored. Subsequently, after receiving new coordinate information (X-coordinate: 600 and Y-coordinate: 600) from the coordinate detector 120, the coordinate storage unit 114 discards the coordinate information and time information whose detection time is “t=20” and stores the new coordinate information (X-coordinate: 600 and Y-coordinate: 600) and time information that indicates detection time when the coordinate was detected (t=50).

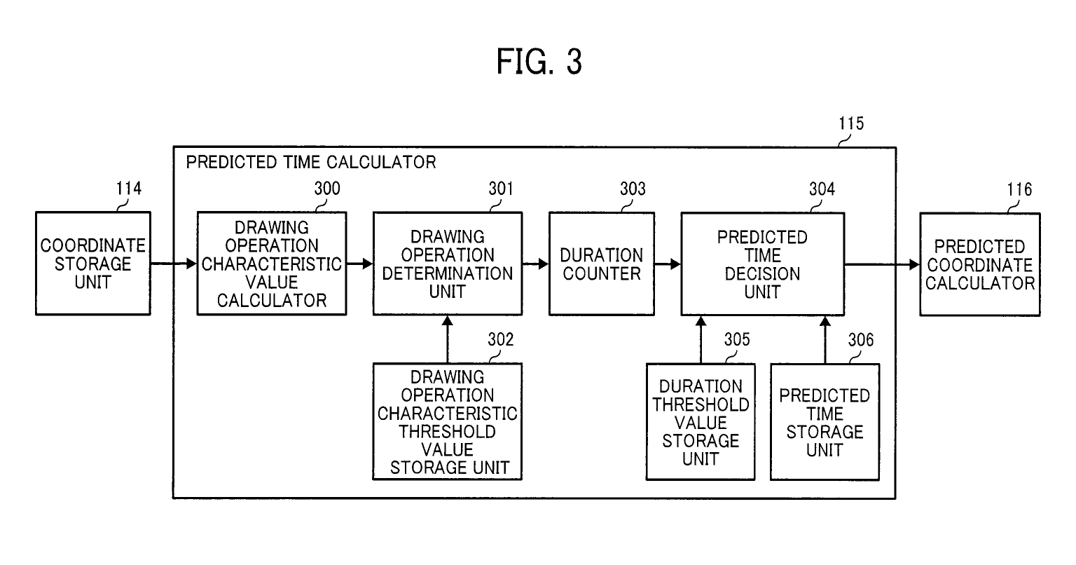

The predicted time calculator 115 calculates predicted time from time when a user instructs to draw at a coordinate to time when the user instructs to draw at next coordinate in a sequence of drawing operation. The predicted time calculator 115 determines predicted time using the coordinate information and time information buffered in the coordinate storage unit 114. A functional configuration of the predicted time calculator 115 will be described in detail later with reference to FIG. 3.

The predicted coordinate calculator 116 calculates coordinate where an object is predicted to contact or approach the coordinate detector 120 after the predicted time passes, that is, predicted coordinates where the user is predicted to instruct to draw after the predicted time passes. The predicted coordinate calculator 116 can calculate the predicted coordinates (x_{pred}, y_{pred}) using equation 1 shown below.

x_{pred}=x_{now}+vₓt_{pred}+½aₓt_{pred}²

y_{pred}=y_{now}+v_{y}t_{pred}+½a_{y}t_{pred}² Equation 1

In equation 1, x_{pred} is an x-coordinate of the predicted coordinate, and y_{pred} is a y-coordinate of the predicted coordinate. x_{now} is the latest buffered x-coordinate, i.e., the most recent drawn x-coordinate. y_{now} is the latest buffered y-coordinate, i.e., the most recent drawn y-coordinate. t_{pred} is the predicted time. vₓ is velocity in the x-axis in the drawing operation, and v_{y} is velocity in the y-axis in the drawing operation. aₓ is acceleration in the x-axis in the drawing operation, and a_{y} is acceleration in the y-axis in the drawing operation. The velocity (vₓ, v_{y}) and the acceleration (aₓ, a_{y}) can be calculated using the buffered coordinate information and time information.

The image generator 117 generates a drawn image displayed on the display unit 130. The image generator 117 generates a drawn image using the coordinate information buffered in the coordinate storage unit 114 and the predicted coordinates calculated by the predicted coordinate calculator 116 and outputs the drawn image to the display controller 118.

The display controller 118 controls the display unit 130. The display controller 118 displays the drawn image generated by the image generator 117 on the display unit 130.

FIG. 3 is a functional block diagram of the predicted time calculator 115 in the image processing apparatus 100. The functional configuration of the predicted time calculator 115 is described below with reference to FIG. 3.

The predicted time calculator 115 includes a drawing operation characteristic value calculator 300, a drawing operation determination unit 301, a drawing operation characteristic threshold value storage unit 302, a duration counter 303, a predicted time decision unit 304, a duration threshold value storage unit 305, and a predicted time storage unit 306.

The drawing operation characteristic value calculator 300 calculates a drawing operation characteristic value that indicates characteristic of a drawing operation. In this embodiment, curvature (k), angle (θ), and acceleration of a drawing operation (|a|) specified by locus of the drawing can be used as drawing operation characteristic values.

In particular, the drawing operation characteristic value calculator 300 approximates the coordinate information ((x₁, t₁), (x₂, t₂), (x₃, t₃) . . . (xᵢ, tᵢ) . . . (x_{Nbuffer}, t_{Nbuffer})) and the coordinate information ((y₁, t₁), (y₂, t₂), (y₃, t₃) . . . (yᵢ, tᵢ) . . . (y_{Nbuffer}, t_{Nbuffer})) by using the least-square method and calculates interpolation curve as quadratic curve shown in equation 2 below. Here, N_{buffer} is a number of coordinates buffered in the coordinate storage unit 114 (1≦i≦N_{buffer}, tᵢ<tᵢ₊₁). That is, x₁ is x-coordinate of the oldest coordinate information buffered in the coordinate storage unit 114, and y₁ is y-coordinate of the oldest coordinate information buffered in the coordinate storage unit 114. t₁ is detection time of x₁ and y₁. x_{Nbuffer} is x-coordinate of the latest coordinate information buffered in the coordinate storage unit 114, and y_{Nbuffer} is y-coordinate of the latest coordinate information buffered in the coordinate storage unit 114. t_{Nbuffer} is detection time of x_{Nbuffer} and y_{Nbuffer}.

x(t)=αₓt²+βₓt+γₛ

y(t)=α_{y}t²+β_{y}t+γ_{y} Equation 2

Here, the coefficients αₓ, βₓ, γₓ, α_{y}, β_{y}, and γ_{y} can be calculated using equation 3 shown below based on the least-square method.

$${T}^{T} T A = {T}^{T} X , T = [ \begin{matrix}{t}_{1}^{2} & {t}_{1} & 1 \\ {t}_{2}^{2} & {t}_{2} & 1 \\ {t}_{Nbuffer}^{2} & {t}_{Nbuffer} & 1\end{matrix} ] , \\ A = [ \begin{matrix}{α}_{x} \\ {β}_{x} \\ {γ}_{x}\end{matrix} ] , X = [ \begin{matrix}{t}_{1} \\ {t}_{2} \\ {t}_{Nbuffer}\end{matrix} ] \\ {T}^{T} T A = {T}^{T} Y , T = [ \begin{matrix}{t}_{1}^{2} & {t}_{1} & 1 \\ {t}_{2}^{2} & {t}_{2} & 1 \\ {t}_{Nbuffer}^{2} & {t}_{Nbuffer} & 1\end{matrix} ] , \\ A = [ \begin{matrix}{α}_{y} \\ {β}_{y} \\ {γ}_{y}\end{matrix} ] , Y = [ \begin{matrix}{t}_{1} \\ {t}_{2} \\ {t}_{Nbuffer}\end{matrix} ] \qquad Equation 3$$

Next, the drawing operation characteristic value calculator 300 can calculate the curvature (k) from the interpolation curve shown in equation 2 based on equation 4 shown below.

$$k = \frac{\dot{x} \ddot{y} - \dot{y} \ddot{x}}{{( {\dot{x}}^{2} + {\dot{y}}^{2} )}^{\frac{3}{2}}} \qquad Equation 4$$

In addition, the angle (θ) is specified by coordinates of adjacent three points included in the coordinate information buffered in the coordinate storage unit 114 and can be calculated by using equation 5 shown below.

$$θ = {cos}^{- 1} ( \frac{\begin{matrix}( {x}_{Nbuffer} - {x}_{Nbuffer - 1} ) ( {x}_{Nbuffer - 2} - {x}_{Nbuffer - 1} ) + \\ ( {y}_{Nbuffer} - {y}_{Nbuffer - 1} ) ( {y}_{Nbuffer - 2} - {y}_{Nbuffer - 1} )\end{matrix}}{( \begin{matrix}( {( {x}_{Nbuffer} - {x}_{Nbuffer - 1} )}^{2} + {( {y}_{Nbuffer} - {y}_{Nbuffer - 1} )}^{2} ) \\ ( {( {x}_{Nbuffer - 2} - {x}_{Nbuffer - 1} )}^{2} + {( {y}_{Nbuffer - 2} - {y}_{Nbuffer - 1} )}^{2}\end{matrix}} \qquad Equation 5$$

Furthermore, the acceleration of a drawing operation (|a|) can be calculated by using equation 6 shown below.

|a|=\sqrt{aₓ²+a_{y}²} Equation 6

The drawing operation determination unit 301 determines continuity of a drawing operation by a user. After comparing the drawing operation characteristic value generated by the drawing operation characteristic value calculator 300 with a predetermined threshold value stored in the drawing operation characteristic threshold value storage unit 302 (hereinafter referred to as “drawing operation characteristic threshold value”), the drawing operation determination unit 301 assumes that continuity of the drawing operation is low (e.g., the drawing is interrupted, or the drawing turns quickly) if the drawing operation characteristic value is larger than the drawing operation characteristic threshold value and initializes the duration counter 303. Alternatively, if the drawing operation characteristic value is smaller than the drawing operation characteristic threshold value, the drawing operation determination unit 301 increments the duration counter 303.

The drawing operation determination unit 301 can determine the continuity of a drawing operation by using not only one of the drawing operation characteristic values (the curvature (k), the angle (θ), and the acceleration of a drawing operation (|a|)) but also more than two of the drawing operation characteristic values. Consequently, the continuity of the drawing operation can be determined more precisely.

The duration counter 303 measures duration of a drawing operation. While the drawing operation characteristic value is smaller than the drawing operation characteristic threshold value, it is determined that the sequence of the drawing operation continues, and value of the duration counter 303 is incremented. Alternatively, if the drawing operation characteristic value exceeds the drawing operation characteristic threshold value, it is determined that the sequence of the drawing operation ended, and the duration counter 303 is initialized.

The predicted time decision unit 304 decides predicted time. The predicted time decision unit 304 decides the predicted time by comparing the value of the duration counter 303 and predetermined threshold value stored in the duration threshold value storage unit 305 (hereinafter referred to as “duration threshold value”).

If the value of the duration counter 303 is larger than the duration threshold value, it is assumed that a long line or large figure etc. is being drawn, and the predicted time decision unit 304 acquires predetermined time (t_{long}) and configures the predetermined time (t_{long}) as the predicted time. Alternatively, if the value of the duration counter 303 is smaller than the duration threshold value, it is assumed that a small character or wavy line is being drawn, and the predicted time decision unit 304 acquires predetermined time (tₛₕₒᵣₜ) and configures the predetermined time (tₛₕₒᵣₜ) as the predicted time.

In this embodiment, t_{long} is longer than tₛₕₒᵣₜ, and it is preferable to configure about 50 ms as t_{long} and about 20 ms as tₛₕₒᵣₜ. In addition, it is preferable to determine the drawn image that the image generator 117 generates based on the predicted time and adopt the most appropriate value as the duration threshold value. In this embodiment, two types of the predicted time are used as described above. However, in other embodiments, more than three types of the predicted time, e.g., about 50 ms (t_{long}), about 35 ms (t_{middle}), and about 20 ms (tₛₕₒᵣₜ), can be used.

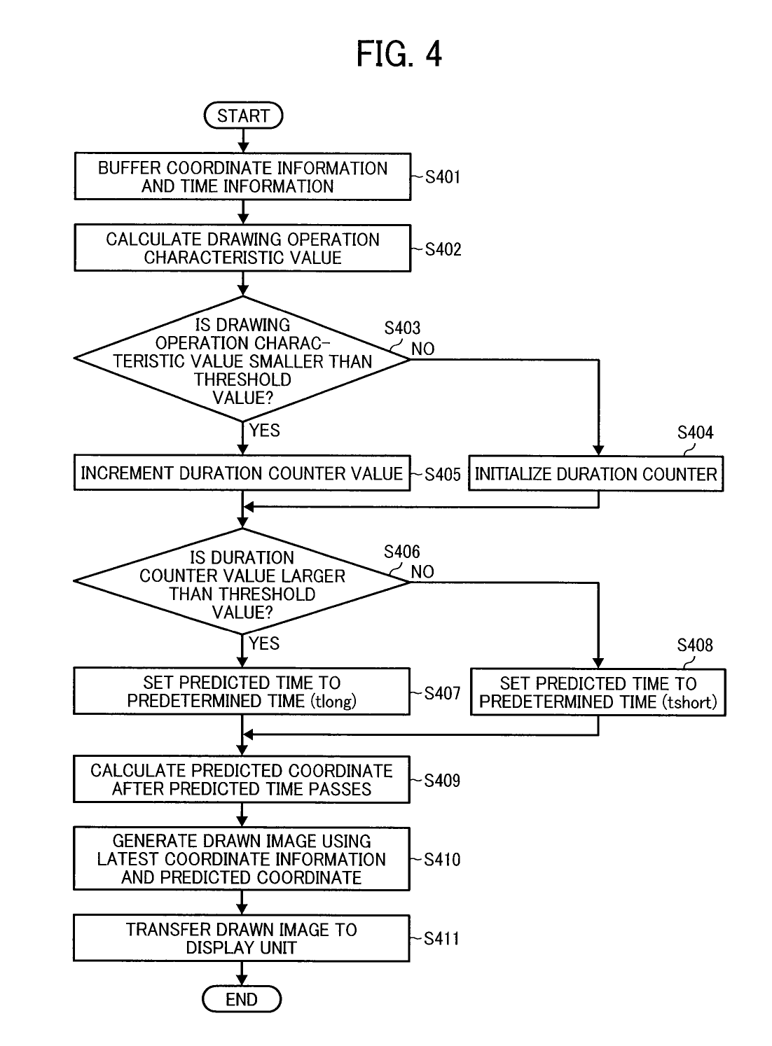

FIG. 4 is a flowchart illustrating a process executed by the controller 110 in the image processing apparatus 100. The process that the controller 110 executes when the controller 110 receives the coordinate information from the coordinate detector 120 is described below with reference to FIG. 4.

The process shown in FIG. 4 starts when the coordinate storage unit 114 in the controller 110 receives the coordinate information from the coordinate detector 120. The coordinate storage unit 114 buffers the coordinate information and the time information in S401. The drawing operation characteristic value calculator 300 in the predicted time calculator 115 calculates the drawing operation characteristic value in S402.

The drawing operation determination unit 301 determines whether or not the drawing operation characteristic value is smaller than the drawing operation characteristic threshold value in S403. If the drawing operation characteristic value is larger than the drawing operation characteristic threshold value (NO in S403), the process proceeds to S404. The drawing operation determination unit 301 initializes the duration counter 303 in S404.

Alternatively, if the drawing operation characteristic value is smaller than the drawing operation characteristic threshold value (YES in S403), the process proceeds to S405. The drawing operation determination unit 301 increments the duration counter 303. The predicted time decision unit 304 determines whether or not the value of the duration counter 303 is larger than the duration threshold value in S406.

If the value of the duration counter 303 is larger than the duration threshold value (YES in S406), the predicted time decision unit 304 sets the predetermined time (t_{long}) to the predicted time in S407. Alternatively, if the value of the duration counter 303 is smaller than the duration threshold value (NO in S406), the predicted time decision unit 304 sets the predetermined time (tₛₕₒᵣₜ) to the predicted time in S408.

The predicted coordinate calculator 116 calculates the predicted coordinates after the predicted time passes in S409. In S410, the image generator 117 generates the drawn image by using the latest coordinate information buffered by the coordinate storage unit 114 and the predicted coordinates calculated in S409. The display controller 118 transfers the drawn image to the display unit 130 and instructs the display unit 130 to display the drawn image in S411, and the process ends.

In this embodiment, the image processing apparatus chooses the predicted time in accordance with the drawn objects such as a small character, dashed line, and large figure and generates the drawn image by calculating the predicted coordinates using the predicted time. That is, the image processing apparatus generates the drawn image by calculating the predicted coordinates using relatively short predicted time if objects such as a small character and dashed line are drawn and error of predicted coordinates is noticeable and using relatively long predicted time if objects such as a large character and straight line are drawn and error of predicted coordinates is unnoticeable. Consequently, prediction accuracy can be improved in case objects whose error of the predicted coordinates is noticeable are drawn, and drawing delay can be kept low.

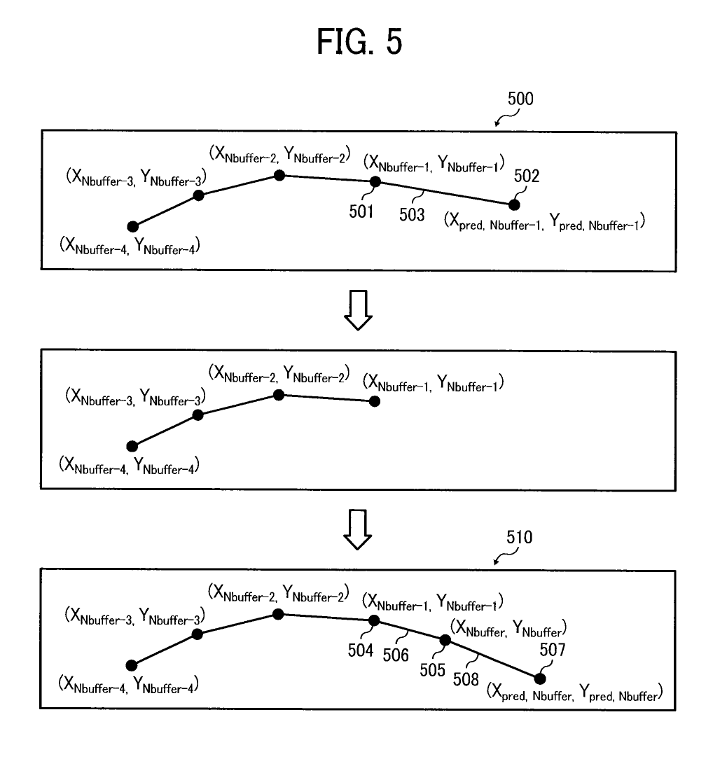

FIG. 5 is a conceptual diagram illustrating a method of generating a drawn image with the image processing apparatus 100. How the image generator 117 in the image processing apparatus 100 generates the drawn image using the coordinate information buffered in the coordinate storage unit 114 and the predicted coordinates is described below with reference to FIG. 5.

A drawn image 500 is generated by a precedent drawing process. Coordinates (X_{Nbuffer-1}, Y_{Nbuffer-1}) 501 are the second latest coordinates buffered in the coordinate storage unit 114. Coordinates (X_{pred,Nbuffer-1}, Y_{pred,Nbuffer-1}) 502 are predicted coordinates calculated in generating the drawn image 500.

First, the image generator 117 deletes a line segment drawn by the predicted coordinates in generating the drawn image 500, i.e., a line segment 503 that connects the coordinates 501 with the coordinates 502, from the drawn image 500. Subsequently, the image generator 117 draws a line segment 506 that connects coordinates 504 with the latest coordinates (X_{Nbuffer}, Y_{Nbuffer}) 505 buffered in the coordinate storage unit 114 as shown in a drawn image 510. After that, the image generator 117 draws a line segment 508 that connects the coordinates 505 with predicted coordinates (X_{pred,Nbuffer}, Y_{pred,Nbuffer}) 507 calculated by using the coordinates 505 and generates the drawn image 510.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

What is claimed is:

1. An image processing apparatus, comprising:
a predicted time calculator to calculate predicted time;
a predicted coordinates calculator to calculate predicted coordinates after the predicted time passes; and
an image generator to generate a drawn image after the predicted time passes by using the predicted coordinates,
wherein the predicted time calculator measures duration of a drawing operation by using coordinate information that indicates coordinates instructed to draw and time information that indicates time when the coordinates are detected, and determines the predicted time in accordance with the duration of the drawing operation.

2. The image processing apparatus according to claim 1, wherein the predicted time calculator calculates characteristic values of the drawing operation by using the coordinate information and the time information and measures the duration of the drawing operation in case the characteristic values of the drawing operation are smaller than a predefined threshold value.

3. The image processing apparatus according to claim 2, wherein the predicted time calculator calculates curvature specified by locus of a drawing, angle specified by the locus of the drawing, and/or acceleration of the drawing operation as the characteristic values of the drawing operation.

4. A method of processing an image, comprising the steps of:
calculating predicted time by using coordinate information that indicates coordinates instructed to draw and time information that indicates time when the coordinates are detected;
calculating predicted coordinates after the predicted time passes; and
generating a drawn image after the predicted time passes by using the predicted coordinates,
the step of calculating the predicted time comprising:
measuring duration of a drawing operation by using the coordinate information and the time information; and
determining the predicted time in accordance with the duration of the drawing operation.

5. The method of processing an image according to claim 4, the step of calculating the predicted time further comprising the steps of:
calculating characteristic values of the drawing operation by using the coordinate information and the time information; and
measuring the duration of the drawing operation in case the characteristic values of the drawing operation are smaller than a predefined threshold value.

6. The method of processing an image according to claim 5, the step of calculating the predicted time further comprising calculating curvature, angle, and/or acceleration of the drawing operation specified by locus of a drawing as the characteristic values of the drawing operation.

7. A processor-readable non-transitory recording medium storing a program that, when executed by a computer, causes the processor to implement a method of processing an image comprising the steps of:
calculating predicted time by using coordinate information that indicates coordinates instructed to draw and time information that indicates time when the coordinate are detected;
calculating predicted coordinates after the predicted time passes; and
generating a drawn image after the predicted time passes by using the predicted coordinates,
the step of calculating the predicted time comprising:
measuring duration of a drawing operation by using the coordinate information and the time information; and
determining the predicted time in accordance with the duration of the drawing operation.
